(19) United States
(12) Patent Application Publication
(10) Pub. No.: US 2003/0033131 A1
(43) Pub. Date: Feb. 13, 2003

(54) SYSTEM LEVEL SIMULATION METHOD AND DEVICE

(76) Inventor: YOSHIYUKI ITO, TOKYO (JP)

Correspondence Address: SUGHRUE MION ZINN MACPEAK & SEAS, 2100 PENNSYLVANIA AVENUE NW, WASHINGTON, DC, 200373202

(21) Appl. No.: 09/299,568

(22) Filed: Apr. 27, 1999

(30) Foreign Application Priority Data
Apr. 28, 1998 (JP) 10-134560

(51) Int. Cl. G06F 9/44

(52) U.S. Cl. 703/20

(57) ABSTRACT

The system level simulation method of the present invention comprises the steps of: dividing the simulation target device into a first circuitry portion and a second circuitry portion; emulating the first circuitry portion by an emulation subject circuit constructed by a rewritable hardware; simulating the second circuitry portion by a partial circuit process substitute section constructed by software; and allowing communication of data between the emulation subject circuit and the partial circuit process substitute section.

### BACKGROUND OF THE INVENTION

1. Field of the Invention

The present invention relates to a system level simulation method and device which includes an operation of an input/output device of a computer, and in particular, to a technique for emulating a simulation target device using a rewritable hardware.

This application is based on Japanese Patent Application No. 10-134560, the content of which is incorporated herein by reference.

2. Description of the Related Art

Japanese Patent Application, First Publication No. Hei 8-110919 discloses an example of a conventional system level simulation device for simulating a simulation target device in a computer system.

FIG. 4 is a block diagram showing the construction of the system level simulation device 5, which includes an instruction level simulator 51 and a logic level simulator 52 which are realized by software.

The instruction level simulator 51 operates faster than the logic level simulator 52, but cannot accurately simulate an entire system which includes an input/output device. In contrast, the logic level simulator 52 can perform an accurate simulation, but operates at a very low speed.

FIG. 5 is a block diagram showing an example of the computer system to be simulated by the system level simulation device 5. The computer system includes a host system 6 and an input/output system 7.

The operation of the conventional system level simulation device 5 will be explained with reference to FIGS. 4 and 5.

The instruction level simulator 51 simulates a processor 61, a system bus 62, a memory 63, and an interface 64 in the host system 6, to simulate the main portion of the computer system. The logic level simulator 52 simulates an input/output manager 72 in the input/output system 7 and performs the input/output operation required for the system level simulation.

Further, using a socket module 65 in the host system 6 simulated by the instruction level simulator 51 and a socket interface 71 simulated by the logic level simulator 52, the host system 6 and the input/output system 7 send the contents of the operations between each other. Thus, the simulation of the system level is carried out.

In the conventional system level simulation device 5 shown in FIG. 4, the instruction level simulator 51 whose processing speed is high simulates the host system 6, while the logic level simulator 51 simulates the input/output system 7 which cannot be accurately simulated by the instruction level simulator 51, thereby improving the speed of the system level simulation.

However, the improvement of the processing speed is limited because the conventional system level simulation device 5 integrates both the instruction level simulator 51 and the logic level simulator 52 which are realized by the software.

Japanese Patent Publication, First Publication No. Hei 8-508599 discloses the technology of mapping the simulation target circuit in an FPGA (Field Programmable Gate Array) and performing the simulation using the same. The FPGA remarkably improves the processing speed, as compared with the technique using an instruction level simulator and the logic level simulator which are realized by software.

To improve the processing speed, an emulator using an FPGA may perform the system level simulation.

An emulator with an FPGA performs the system level simulation significantly faster than the system level simulation device of FIG. 4.

However, there is a problem with an emulator with an FPGA, which will be discussed below:

At the time of computer system development, a system level simulation is often required even though the specifications of a part of the host system is not fixed, but an emulator with an FPGA which can emulate the operations of all the elements in the computer system must be prepared. For example, even when the specifications of the elements other than the processor in the computer system are not fixed, it is necessary to build an emulator which can emulate all the elements such as a system bus and a memory.

It takes much time and labor to build an emulator with an FPGA. Preparing an emulator with an FPGA for the elements whose specifications are not fixed involves the risk of being labor- and time-consuming, and the system level simulation may not be executed efficiently. That is, when the provisional specification of the element, for which the emulator is built, differs from the specification fixed later, another emulator must be produced, resulting in an inefficient system level simulation. Further, because the processing speed of the emulator with the FPGA differs from that of the emulation target device, it is difficult to perform the operation and the management of the input/output device and other devices which are externally added to the emulation target device. Therefore, the external input/output device must be included in the emulation target, or an interface for matching the processing speeds must be provided, and this is a cause of increased labor to produce the emulator.

### BRIEF SUMMARY OF THE INVENTION

It is therefore an object of the present invention to provide a system level simulation method and device for performing the simulation efficiently and quickly.

The system level simulation method for simulating a simulation target device of the present invention, comprises the steps of: dividing the simulation target device into a first circuitry portion and a second circuitry portion; emulating the first circuitry portion by an emulation subject circuit constructed by a rewritable hardware; simulating the second circuitry portion by a partial circuit process substitute section constructed by software; and allowing communication of data between the emulation subject circuit and the partial circuit process substitute section.

The system simulation method of the present invention further comprises the step of: calling an operating system from the partial circuit process substitute section; and simulating the input/output process of the second circuitry portion using the operating system. The rewritable hardware is an FPGA.

The present invention provides the communication means for sending and receiving data required for the simulation between the emulation subject circuit and the partial circuit process substitute section. Therefore, the boundary between the first circuitry portion emulated by the emulation subject circuit and the second circuitry portion simulated by the partial circuit process substitute section can be freely adjusted. That is, every time a new additional specification is decided, the structure for emulating the element whose specification is newly decided can be added to the emulator subject circuit, making the system level simulation efficient.

Further, the emulator subject circuit with the rewritable hardware such as the FPGA emulates the element whose specification is fixed, thus increasing the processing speed.

Furthermore, the OS simulates the input/output operation of the second circuitry portion, simplifying the structure of the partial circuit process substitute section.

In another aspect of the present invention, the system level simulation device for simulating a simulation target device comprises: an emulation subject circuit for emulating a first circuitry portion in the simulation target device, the emulation subject circuit being constructed by rewritable hardware; a partial circuit process substitute section for simulating a second circuitry portion in the simulating target device, the partial circuit process substitute section being constructed by software; and a communicator for communicating the data required for the simulation between the emulation subject circuit and the partial circuit process substitute section.

The system level simulation device further comprises: an operating system caller for calling an operating system which simulates the input/output process performed by the second circuitry portion. The rewritable hardware is an FPGA.

In the computer readable medium containing program instructions for simulating a simulation target device, the program instructions include instructions for performing the steps comprising: dividing the simulation target device into a first circuitry portion and a second circuitry portion; emulating the first circuitry portion by an emulation subject circuit constructed by a rewritable hardware; simulating the second circuitry portion by a partial circuit process substitute section constructed by software; and allowing communication of data between the emulation subject circuit and the partial circuit process substitute section by a communicator.

The program instructions include instructions for performing the step of realizing the partial circuit process substitute section and the communicator in a computer by software.

### BRIEF DESCRIPTION OF THE DRAWINGS

FIG. 1 is a block diagram showing an embodiment of the present invention.

FIG. 2 is a flow chart showing the operation of an embodiment of the present invention.

FIG. 3 is a diagram showing an example of the present invention.

FIG. 4 is a block diagram showing the background art.

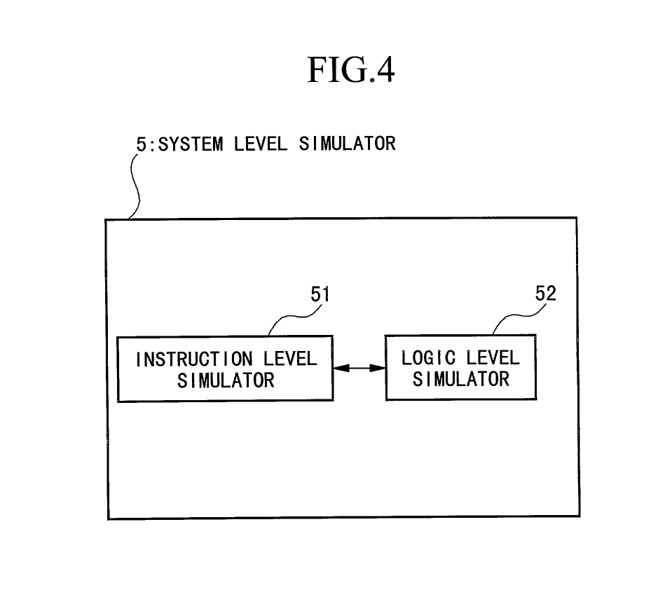

FIG. 5 is a block diagram explaining the operation of the background art.

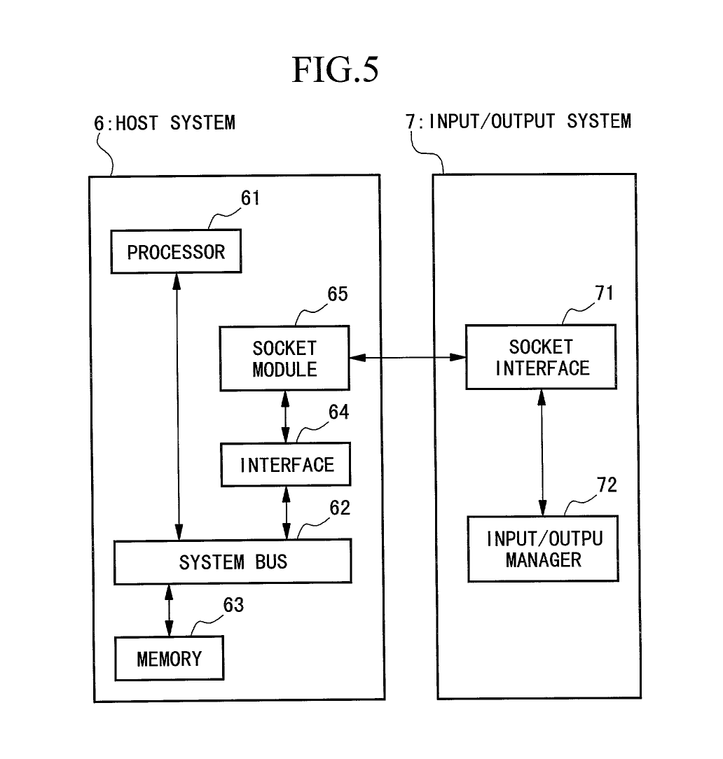

### DETAILED DESCRIPTION OF THE INVENTION

The best mode of the embodiment of the present invention will be explained.

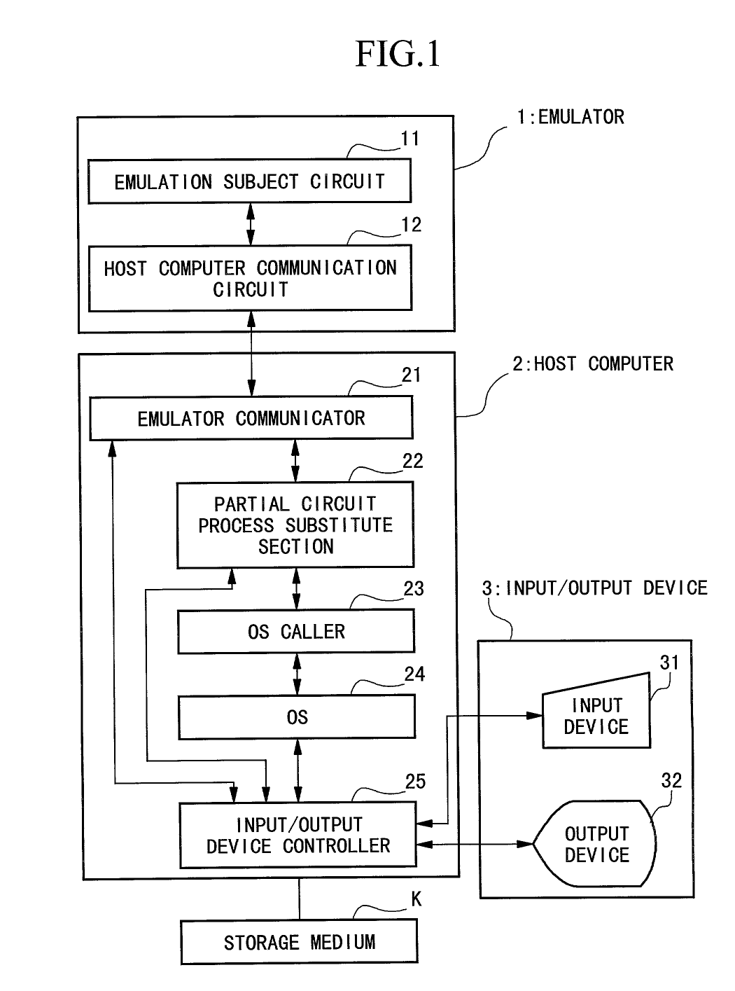

FIG. 1 is a block diagram showing the embodiment of the present invention, which includes an emulator 1 using rewritable hardware, a host computer 2 controlled by a computer program, an input/output device 3 which comprises an input device 31 such as a keyboard and an output device 32 such as a display, and a storage medium K.

The emulator 1 using the rewritable hardware has an emulation subject circuit 11 and a host computer communication circuit 12.

The emulation subject circuit 11, which is constructed by the rewritable hardware, performs equivalently to a part of the circuit (first circuitry portion) whose design specification is fixed and which can be emulated by the rewritable hardware. The rewritable hardware may be, for example, an FPGA. For example, the interface section communicating with the input/output device cannot be emulated by the rewritable hardware, because the operation speed of the input/output device differs from that of the rewritable hardware.

The host computer communication circuit 12 controls the operation of the emulation subject circuit 11 according to an instruction from the host computer 2, and notifies the host computer 2 of the content of the operation of the emulation subject circuit 11. The content of the operation may be an input request, an output request, a termination notification, and the status of a proceeding address in the computer system, which are issued by the first circuit portion emulated by the emulation subject circuit 11. The content of the operation can be extracted through the signal line connected to the corresponding section in the emulation subject circuit 11 of the FPGA.

The host computer 2 has an emulator communicator 21, a partial circuit process substitute section 22 performed by software, an OS (operating system) 24, an OS caller 23, and an input/output device controller 25.

On reception of the content of the operation sent from the emulator 1, the emulator communicator 21 sends the content to the partial circuit process substitute section 22 or operates the input/output device controller 25, and notifies the emulator 1 of the content of the control operation issued from the partial circuit process substitute section 22 to the emulation subject circuit 11.

The partial circuit process substitute section 22 simulates the other part of the simulation target circuit (the second circuitry portion), which is not emulated by the emulation subject circuit 11. Specifically, the partial circuit process substitute section 22 has functions of performing the processes corresponding to the content of the operations of the emulation subject circuit 11 sent from the emulator communicator 21, requesting the OS caller 23 to call the OS 24, and sending the content of the operation of controlling the emulation subject circuit 11 to the emulator communicator 21.

The OS caller 23 generates an argument corresponding to the content of the operation in response to the request sent from the partial circuit process substitute section 22, and, asynchronously with the process of the OS 24, sends the return value to the partial circuit process substitute section 22, assuming the content of the operation of the second circuitry portion.

The OS 24 directs the input/output device controller 25 to output the data to the output device 32, to store the data input from the input device 31, and to send the input data in response to the request from the OS caller 23, thus managing the input/output device 3.

The storage medium K connected to the host computer 2 may be a disc, a semiconductor memory, or other storage media, and stores the program for executing the system level simulation. The program is read by and controls the host computer 2 so as to realize the emulator communicator 21, the partial circuit process substitute section 22, and the OS caller 23 in the host computer 2.

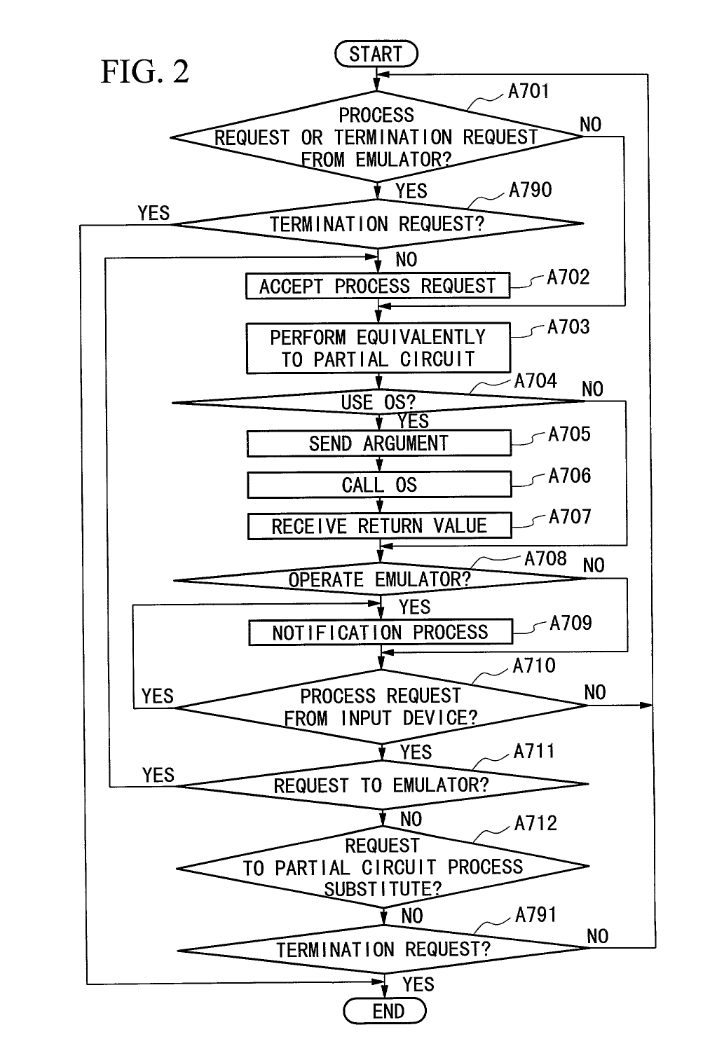

FIG. 2 is a flow chart showing the operation of the apparatus of FIG. 1. In the following, the operation of the embodiment of the present invention will be explained with reference to FIGS. 1 and 2.

The emulation subject circuit 11 in the emulator 1 successively emulates the operation of the first circuitry portion which is the emulation target, and notifies the content of the operation to the host computer 2 using the host computer communication circuit 12.

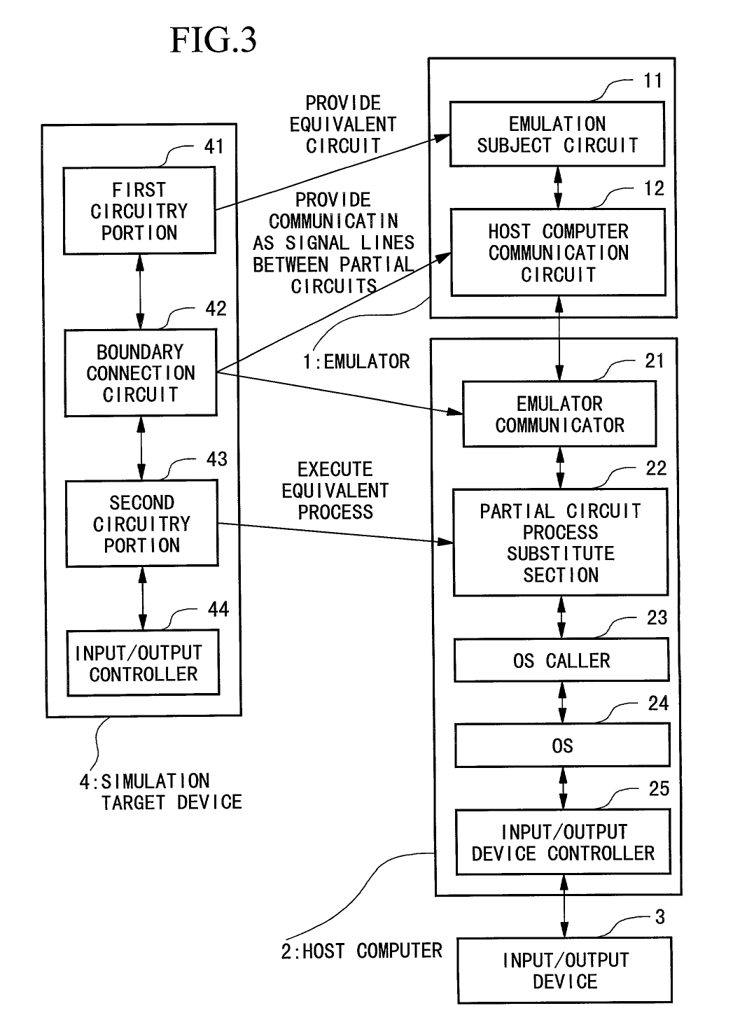

When the content of the operation of the first circuitry portion emulated by the emulation subject circuit 11 is informed to the host computer 2 through the host computer communication circuit 12 and the emulator communicator 21, the partial circuit process substitute section 22 analyzes the content of the operation, and determines whether the process request or the termination report is received from the emulation subject circuit 11 (step A701 in FIG. 3). When a process request such as the input request or the output request is received, the partial circuit process substitute section 22 accepts the request (step A702).

The partial circuit process substitute section 22 carries out the sequence equivalent to that of the second circuitry portion which is not emulated by the emulation subject circuit 11, and, when accepting the process request from the emulator 1, performs the process corresponding to the request (step A703).

When the partial circuit process substitute section 22, which performs the process of the second circuitry portion (step A703), requires the OS 24, the OS caller 23 sends the argument (step A705) to call the OS 24 (step A706), and receives the return value when the process under the OS 24 terminates (step A707).

By controlling the input/output device controller 25 in response to the call, the OS 24 stops and starts the input device 31 which is the keyboard, and outputs the data to the output device 32 which is the display.

When the partial circuit process substitute section 22, which performs the process of the second circuitry portion (step A703), is requested to control the emulator 1 (step A708), the partial circuit process substitute section 22 controls the emulation subject circuit 11 through the emulation communicator 21 and the host computer communication circuit 12 (step A710).

When the process request is received from the input device 31 of the keyboard, that is, when the OS 24 retains the process request sent from the input device 31 (step A710), the OS caller 23 determines whether the process request is to the emulator 1 or to the partial circuit process substitute section 22 (steps A711 and A712).

When the process request is to the emulator 1, the request is sent to the partial circuit process substitute section 22, which is then instructed to notify the emulator 1 (step A709). In contrast, when the process request is to the partial circuit process substitute section 22, the request is sent to the partial circuit process substitute section 22, which then performs the operation corresponding to the request (steps A702 and A703).

When the content of the operation sent from the emulator 1 includes the termination report (step A790), or when the process request input from the input device 31 of the keyboard is the termination request (step A791), the partial circuit process substitute section 22 terminates its process.

In the embodiment, both the emulation subject circuit 11 provided by the rewritable hardware and the partial circuit process substitute section 22 provided by the software in the host computer 2 are operated in a parallel processing manner, while sending and receiving the data required for the simulation through the host computer communication circuit 12 and the emulator communicator 21. Therefore, the first circuitry portion whose specification is fixed in the simulation target device is emulated by the emulation subject circuit 11, while the second circuitry portion, other than the first circuitry portion, can be simulated by the partial circuit process substitute 22, thereby making the system level simulation efficient.

The emulation subject circuit 11, which requires much time and labor to produce, has only to emulate the process of the first circuitry portion whose specification is fixed. As compared with the conventional method in which the emulation subject circuit emulates all elements in the simulation target device, the emulation subject circuit 11 can be produced quickly, thereby making the system level simulation efficient. Further, when an additional specification is decided, the structure for emulating the corresponding portion may be added to the emulation subject circuit 11. Therefore, as compared with the conventional method in which the emulation subject circuit emulates all elements in the simulation target device, the present invention avoids unnecessary change of the completed emulation subject circuit 11. Depending on the change of the emulation subject circuit 11, the partial circuit process substitute section 22 must be modified, but can be easily adapted because it is provided by the software.

The operation of the present invention will be explained in detail with reference to an example.

As shown in FIG. 3, the simulation target device 4 is divided into the first circuitry portion 41, whose specification is fixed and can be emulated by the rewritable hardware, and the second circuitry portion 43 other than the first circuitry portion. Further, the connection between the first circuitry portion 41 and the second circuitry portion 43 is separated as a boundary connection circuit 42.

To simulate the simulation target device 4, the emulator 1 packages the emulation subject circuit 11 which is provided by the rewritable hardware and performs equivalently to the first circuitry portion 41. The host computer 2 provides a partial circuit process substitute section 22 which performs equivalently to the second circuitry portion 43 and is provided by the software.

The emulation subject circuit 11 in the emulator 1 carries out the process of the first circuitry portion 41.

On the other hand, the partial circuit process substitute section 22 in the host computer 2 carries out the process of the second circuitry portion 43 (step A703).

The data transmission between the first circuitry portion 41 and the second circuitry portion 43 is realized by the communication between the emulation subject circuit 11 and the partial circuit process substitute section 22 through the host computer communication circuit 12 and the emulator communicator 21.

The operation in which the second circuitry portion 43 in the simulation target device 4 controls the input/output controller 44, can be simulated by operating the input/output device controller 25 from the partial circuit process substitute section 22 through the OS caller 23 and the OS 24 (steps A705 to A707).

While in this embodiment, the operation in which the second circuitry portion 43 controls the input/output controller 44 is simulated by the OS 24, the partial circuit process substitute section 22 may simulate the operation. In this case, the process performed by the OS 24 must be incorporated in the partial circuit process substitute section 22. This may lengthen the time required to produce the partial circuit process substitute section 22, and therefore, the construction of the above embodiment is preferable.

As described above, the present invention provides a communication means for sending and receiving data required for the simulation between the emulation subject circuit and the partial circuit process substitute section. Therefore, the boundary between the first circuitry portion emulated by the emulation subject circuit and the second circuitry portion simulated by the partial circuit process substitute section can be freely adjusted. That is, every time a new additional specification is decided, the structure for emulating the element whose specification is newly decided can be added to the emulator subject circuit, making the system level simulation efficient.

Further, the emulator subject circuit with the rewritable hardware such as an FPGA, emulates the element whose specification is fixed, thus increasing the processing speed.

Furthermore, the OS simulates the input/output operation of the second circuitry portion, simplifying the structure of the partial circuit process substitute section.

This invention may be embodied in other forms or carried out in other ways without departing from the spirit thereof. The present embodiments are therefore to be considered in all respects illustrative and not limiting, the scope of the invention being indicated by the appended claims, and all modifications falling within the meaning and range of equivalency are intended to be embraced therein.

1. A system level simulation method for simulating a simulation target device, comprising the steps of:
dividing said simulation target device into a first circuitry portion and a second circuitry portion;
emulating said first circuitry portion by an emulation subject circuit constructed by rewritable hardware;
simulating said second circuitry portion by a partial circuit process substitute section constructed by software; and
allowing communication of data between said emulation subject circuit and said partial circuit process substitute section.

2. A method according to claim 1, further comprising the step of:
calling an operating system from said partial circuit process substitute section; and
simulating the input/output process of said second circuitry portion using said operating system.

3. A method according to the claim 1, wherein said rewritable hardware is an FPGA.

4. A system level simulation device for simulating a simulation target device, comprising:
an emulation subject circuit for emulating a first circuitry portion in said simulation target device, said emulation subject circuit being constructed by a rewritable hardware;
a partial circuit process substitute section for simulating a second circuitry portion in said simulating target device, said partial circuit process substitute section being constructed by software; and
a communicator for transmitting data required for the simulation between said emulation subject circuit and said partial circuit process substitute section.

5. A device according to claim 4, further comprising:
an operating system caller for calling an operating system which simulates the input/output process performed by said second circuitry portion.

6. A device according to claim 5, wherein said rewritable hardware is an FPGA.

7. A computer readable medium containing program instructions for simulating a simulation target device, the program instructions including instructions for performing the steps comprising:
dividing said simulation target device into a first circuitry portion and a second circuitry portion;
emulating said first circuitry portion by an emulation subject circuit constructed by a rewritable hardware;
simulating said second circuitry portion by a partial circuit process substitute section constructed by software; and
allowing communication of data between said emulation subject circuit and said partial circuit process substitute section by a communicator.

8. A computer readable medium according to claim 7, wherein the program instructions include instructions for performing the step of providing said partial circuit process substitute section and said communicator in a computer by software.
